(19) United States
(12) Patent Application Publication
(10) Pub. No.: US 2011/0119845 A1
(43) Pub. Date: May 26, 2011

(54) GUN BORE CLEANING SYSTEM

(76) Inventor: Han Goo Kim, Kyonggi-Do (KR)

(21) Appl. No.: 12/715,655

(22) Filed: Mar. 2, 2010

(30) Foreign Application Priority Data
Nov. 24, 2009 (KR) 10-2009-0113742

(51) Int. Cl. B08B 9/00

(52) U.S. Cl. 15/104.05

(57) ABSTRACT

A gun bore cleaning system is provided. The cleaning system may be easily transported by a user, is convenient to work with, involves virtually no equipment malfunction problems, and is accessibly priced. A cleaning member is provided to be inserted into a gun barrel, a wire is connected to either end of the cleaning member, and the free end of either wire is connected to a wire moving device at the breech and the muzzle, respectively, of the gun barrel. Thus, when a wire is selectively wound at one of either end of the barrel, the cleaning member is moved to remove soots and other deposits from inside the gun barrel to conveniently clean the barrel. Thus, fast and accurate gun bore cleaning can be achieved for the sake of combat readiness, by reducing personnel requirements and the time taken for cleaning gun barrels by about 30%.

### BACKGROUND

The present disclosure relates to a cleaning apparatus for cleaning the bores of guns on self-propelled artillery, mortars, etc., and more particularly, to a gun bore cleaning system capable of easily cleaning the inside of a gun barrel with a cleaning member connected to wires so that it can be pulled in both directions within the barrel.

In general, the insides of bores of guns on self-propelled artillery, mortars, etc. must be cleaned in a suitable way after the guns are used. If cleaning is not performed properly, soots and other residue can drastically lower the gun's performance.

Thus, the related art provides a method of manually cleaning the inside of a barrel by inserting a cleaning member attached at the end of a rod of a certain length into the barrel and moving the cleaning member back and forth with the rod, and methods for automatic cleaning using automatic cleaners.

The automatic methods, however, involve high production costs due to the need to install a driving device, and significantly lower workability due to frequent malfunctions. Therefore, problems arise in terms of affordability due to higher manufacturing costs, and user inconvenience from frequently having to maintain and repair the cleaner instead of using the cleaner to clean gun barrels.

Specifically, an automatic barrel cleaner can cost around 20 million Korean won (almost US$20,000), and the substantial size and weight of the equipment prohibit easy transport by human workers, thus rendering it unsuitable for training and exhibition. Also, because it is fully automatic and employs a motor, when the automatic barrel cleaner suffers equipment failure while cleaning a barrel, repair of the equipment is very difficult to perform.

Also, automatic cleaners are actually almost never used in the field (in an artillery unit), and because artillery crew that man pieces of ordnance believe that manual cleaning of gun bores is more efficient than using automatic cleaners, for the most part, the insides of barrels are being cleaned manually.

Such methods for manually cleaning insides of gun barrels, however, have the following limitations. Because front to rear movement of the cleaning member inserted in the gun barrel progresses in a single direction—that is, from the end of the barrel from which shells are fired toward the end into which shells are loaded, by means of moving the rod from front to rear, the rod must be made of a length corresponding to the length of the gun barrel (about 8 meters). Thus, the cleaning member that is moved from front to rear by the rod of the certain length moves non-uniformly, resulting in non-uniform cleaning over different regions within the gun barrel.

Further, when a related art cleaning member attached to a rod undergoes prolonged use and is subject to constant wear, it may not clean thoroughly and completely remove soots deposits.

In addition, a certain number of personnel (7 soldiers, for example) is required to move the cleaning member forward and rearward, hindering crew deployment, and cleaning of a gun bore cannot be performed quickly, taking a considerable amount of time (e.g., 45-50 minutes) to complete.

### SUMMARY

Embodiments provide a gun bore cleaning system capable of easily cleaning the inside of a gun barrel with a cleaning member connected to wires, so that it can be pulled in both directions within the barrel by pulling the wires from either end outside the barrel.

Embodiments also provide a gun bore cleaning system capable of quickly and precisely cleaning the inside of a gun barrel, by positioning a wire moving device at the shell loading end (breech) and at the shell firing end (muzzle) of the gun barrel and connecting a wire to each moving device, to automate the pulling operation of the wires.

In one embodiment, a gun bore cleaning system includes: a cleaning member inserted into a gun barrel of a predetermined length, and moved forward and rearward between a shell loading end and a shell firing end of the barrel to remove soots and other deposits from inside the barrel; a plurality of wires connected to either end of the cleaning member, respectively, to move the cleaning member forward and rearward between the shell loading end and the shell firing end within the barrel; and a plurality of moving devices for winding and unraveling and moving the wires forward and rearward.

The cleaning member may include: a brush for moving forward and rearward within the barrel while supplying oil to clean the inside of the barrel; an oil applicator/remover formed at either side of the brush, for absorbing and removing the oil from an inner surface of the barrel cleaned by the brush; a fixed body coupled to the oil applicator/remover, respectively; and a ring portion connected and fixed to the fixed body, for the wire to be latched to.

The brush, oil applicator/remover, fixed body, and ring portion may be configured to couple integrally.

The brush, oil applicator/remover, fixed body, and ring portion may be configured as separate components that may be combined to facilitate maintenance and care.

The fixed body may include: a first body to which the brush and the oil applicator/remover are coupled; and a first and a second body cover coupled by the ring portions to a front and rear end of the first body, respectively, wherein the first body, the first body cover, and the second body cover may define screw holes in a lengthwise direction, for the ring portions to be screw-coupled therein.

The moving device may be a device for unwinding and pulling the wire.

The moving device may be a powered moving device, or a manual moving device for unidirectional rotation by means of a rotation lever.

The manual moving device may include: a wire roller guide; a rotating drum having a unidirectional first gear, for unraveling and pulling wire guided by the wire roller guide; and a second gear and pulley, configured with a plurality of teeth, for engaging with teeth of the first gear of the rotating drum to prevent rotation in an unraveling direction when the wire is pulled, and for disengaging from the teeth of the first gear of the rotating drum and allowing rotation in the unraveling direction when the wire is unraveled.

The first and second gears may be engaged or disengaged through a connecting gear.

The manual moving device may include: a wire roller guide; a rotating drum having a unidirectional first gear, for unraveling and pulling wire guided by the wire roller guide; and a catch for catching on the first gear of the rotating drum and preventing rotation in an unraveling direction when the wire is pulled, and for disengaging from the first gear of the rotating drum to allow rotation in the unraveling direction when the wire is unraveled.

The details of one or more embodiments are set forth in the accompanying drawings and the description below. Other features will be apparent from the description and drawings, and from the claims.

### BRIEF DESCRIPTION OF THE DRAWINGS

FIG. 1 is a configurative view of a cleaning member according to an embodiment.

FIG. 2 is a schematic phantom view showing a cleaning member being used to clean the bore of a gun, according to an embodiment.

FIGS. 3A and 3B are configurative views of a manual moving device according to embodiments.

FIG. 4 is an exploded perspective view of a cleaning member that can be disassembled, according to another embodiment.

FIG. 5 is a sectional view of a cleaning member that can be disassembled, according to another embodiment.

FIG. 6 is a configurative view of a manual moving device with a catch, according to another embodiment.

### DETAILED DESCRIPTION OF THE EMBODIMENTS

Reference will now be made in detail to the embodiments of the present disclosure, examples of which are illustrated in the accompanying drawings.

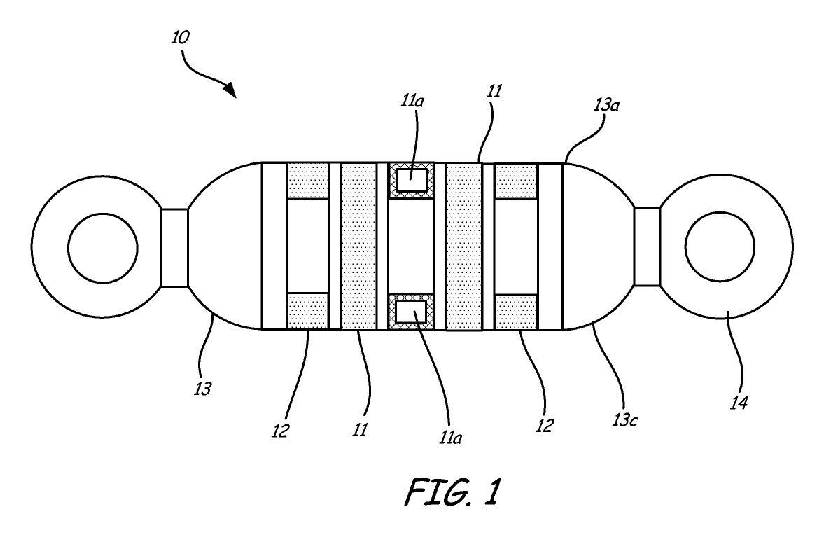

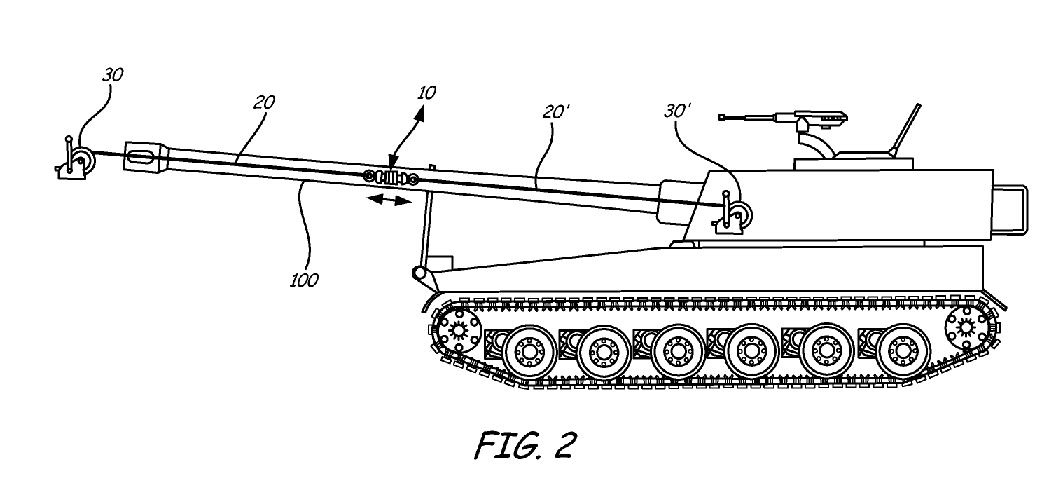

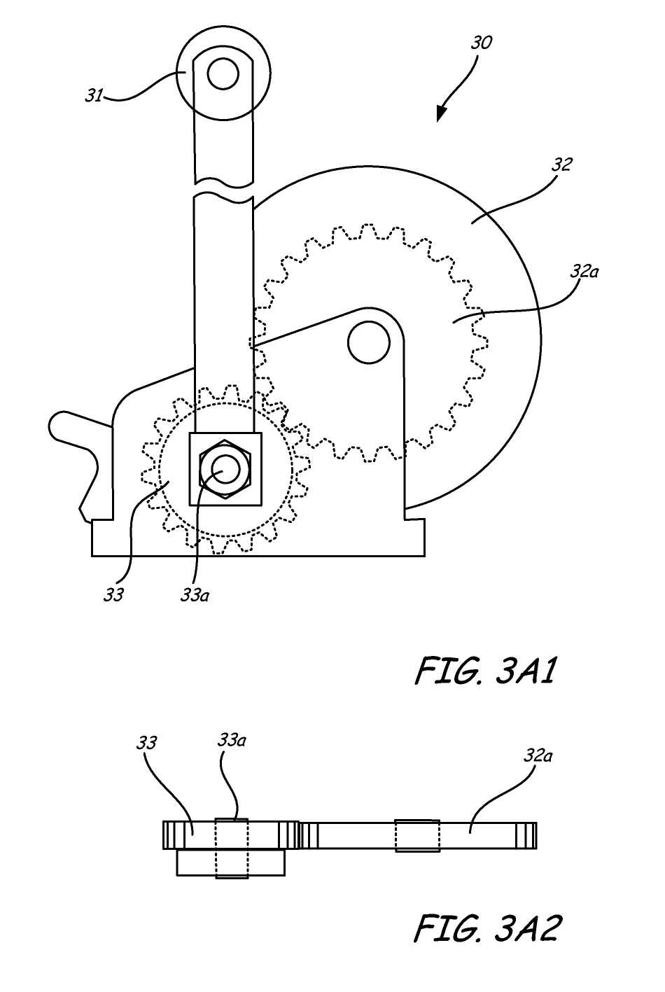

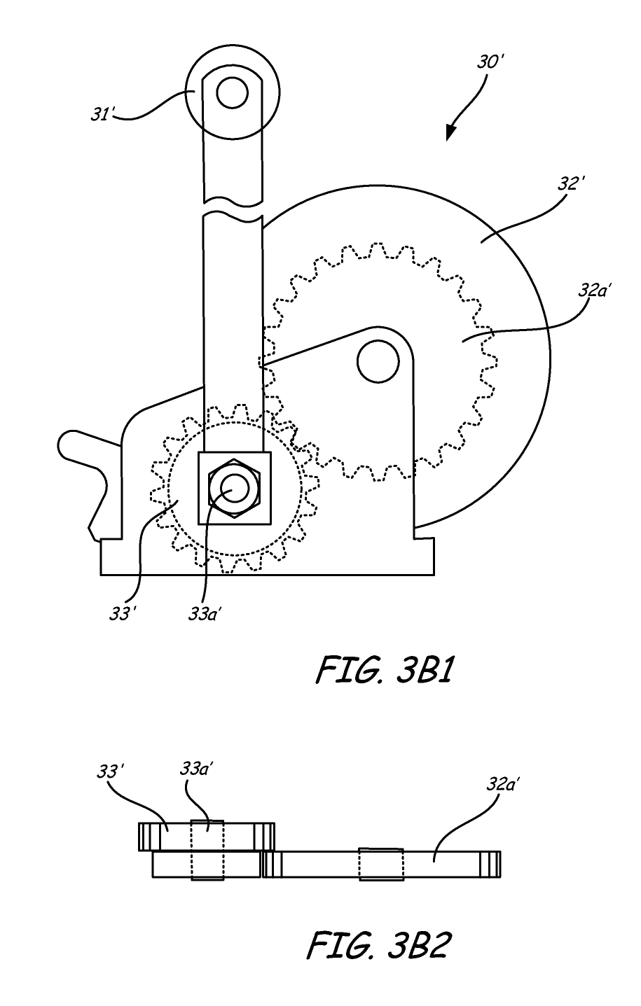

FIG. 1 is a configurative view of a cleaning member according to an embodiment, FIG. 2 is a schematic phantom view showing a cleaning member being used to clean the bore of a gun, according to an embodiment, and FIGS. 3A and 3B are configurative views of a manual moving device according to embodiments.

Referring to the drawings, a gun bore cleaning system according to an embodiment includes a cleaning member 10, wires 20 and 20′, and moving devices 30 and 30′.

The cleaning member 10 is configured to be inserted inside a gun barrel 100 of a certain length and moved within the barrel 100 between the shell loading end and the shell firing end in order to remove soots and other residue from inside the barrel 100, and includes an oil applicator/remover 12 installed at either side of a pair of brushes 11 flanking both sides of an oil supplier 11a at the center of the cleaning member 10, a fixed body 13 supporting the former elements, and a ring portion 14 at the left and right ends.

The brush 11 is for cleaning the inside of the barrel 100 when oil is supplied by the oil supplier 11a in the barrel 100, and is configured with a diameter that fits the inside of the barrel 100.

The oil applicator/remover 12, being coupled to either side of the assembly made up of the oil supplier 11a flanked by the brushes 11, is for removing oil from the inside of the barrel 100 whose surface has been cleaned with oil by the brush 11, and is configured of sponge or fabric.

Here, oil may be adsorbed to one of the pair of oil applicators/removers 12 in order to raise cleaning efficiency.

The fixed body 13 is designed to fit the inner diameter of the barrel 100, and is coupled to each of the oil applicators/removers 12.

The ring portions 14 are connected and fixed to the fixed body 13, and are eye bolts to which the wires 20 and 20′ are latched for fastening and coupling to the fixing body 13.

The wires 20 and 20′ are inserted into the shell loading end (breech) and shell firing end (muzzle) of the gun barrel 100 and respectively connected and fixed to the ring portions 14 of the cleaning member 10 to move the cleaning member 10 forward and rearward. In embodiments, rope may be used instead of the wires 20 and 20′, and therefore, the term “wire” used herein should not be interpreted verbatim since it includes the concept of a rope.

The moving devices 30 and 30′ are installed at the shell loading end (breech) and the shell firing end (muzzle), respectively, of the gun barrel, and are configured to pull the wires 20 and 20′.

Here, the moving devices 30 and 30′ are configured as manual moving devices such as powered moving devices or rotating levers (not shown) for unidirectional rotation, and the manual moving devices include, as shown in FIGS. 3A and 3B, wire roller guides 31 and 31′, rotating drums 32 and 32′ with unidirectional first gears 32a and 32a′ for unraveling or pulling wires 20 and 20′ guided by the wire roller guides 31 and 31′, second gears 33 and 33′ with pluralities of teeth that are engaged with gear teeth of the first gears 32a and 32a′ to prevent rotation in the unraveling direction when the wires 20 and 20′ are being pulled and are disengaged from the gear teeth of the first gears 32a and 32a′ of the rotating drums 32 and 32′ to allow rotation in the unraveling direction when the wires 20 and 20′ are unraveled, and pulleys 33a and 33a′.

Here, the first gears 32a and 32a′ and the second gears 33 and 33′ are configured to be engaged or disengaged with gear teeth.

Specifically, with a gun bore cleaning system according to embodiment, as shown in FIGS. 1 to 3, the moving devices 30 and 30′ provided in plurality are first fixed firmly using a magnet and fixing belt at the shell loading end and the shell firing end, respectively, of a gun barrel 100.

Next, the wires 20 and 20′ are connected to the eye bolt ring portions 14 at either end of the cleaning member 10, and oil (for bore cleaning) is applied to the brushes 11 on the cleaning member 10.

Then, levers of the moving devices 30 and 30′ installed at the shell loading end and shell firing end of the barrel 100 are selectively manipulated to move the wires 20 and 20′ forward and rearward, to perform cleaning and remove soots and other deposits from inside the barrel 100 with oil supplied from the brushes 11 of the cleaning member 10.

Here, when cleaning is performed inside the barrel 100 by the oil from the brushes 11, the sponge or fabric oil applicators/removers 12 coupled at either side of the brushes 11 with the oil supplier 11a in the middle absorb and remove residual oil from inside the barrel 100, in order to prevent oil from dribbling down during cleaning the inside of the barrel 100 with oil.

That is, in order to pull the wire 20 toward the moving device 30 in FIG. 2, the rotating drum 32 in FIG. 3A rotates in a state where the first gear 32a formed thereon is engaged to the second gear 33.

On the other hand, the second gear 33′ in FIG. 3B is not engaged with the first gear 32a′ formed on the rotating drum 32′, and the pulley 33a′ is disposed to allow the rotating drum 32′ and the first gear 32a′ to rotate freely, so that the wire 20 may be pulled when the rotating drum 32 shown in FIG. 3A is rotated and is prevented from unraveling.

Conversely, in order to pull the wire 20′ in the direction of the moving device 30′ shown in FIG. 2, the rotating drum 32′ in FIG. 3B is rotated in a state where the second gear 33′ is engaged with the first gear 32a′ formed on the rotating drum 32′.

Here, the second gear 33 in FIG. 3A is not engaged with the first gear 32a formed on the rotating drum 32, and the pulley 33a is disposed to allow the rotating drum 32 and the first gear 32a to rotate freely, so that the wire 20′ may be pulled when the rotating drum 32′ shown in FIG. 3B is rotated and is prevented from unraveling.

When the cleaning member 10 is thus moved forward and rearward multiple times, where the brushes 11 clean the inside of the barrel 100 with oil, and the oil applicators/removers 12 subsequently absorb and remove the oil that has been used by the brushes 11 to clean the inside of the barrel 100, the use of the gun bore cleaning system according to embodiments allows the process of “transport-installation-cleaning-removal-relocation” to be completed in about 25 minutes by a maximum of 2 crew members, while completing cleaning of the inside of the gun barrel 100.

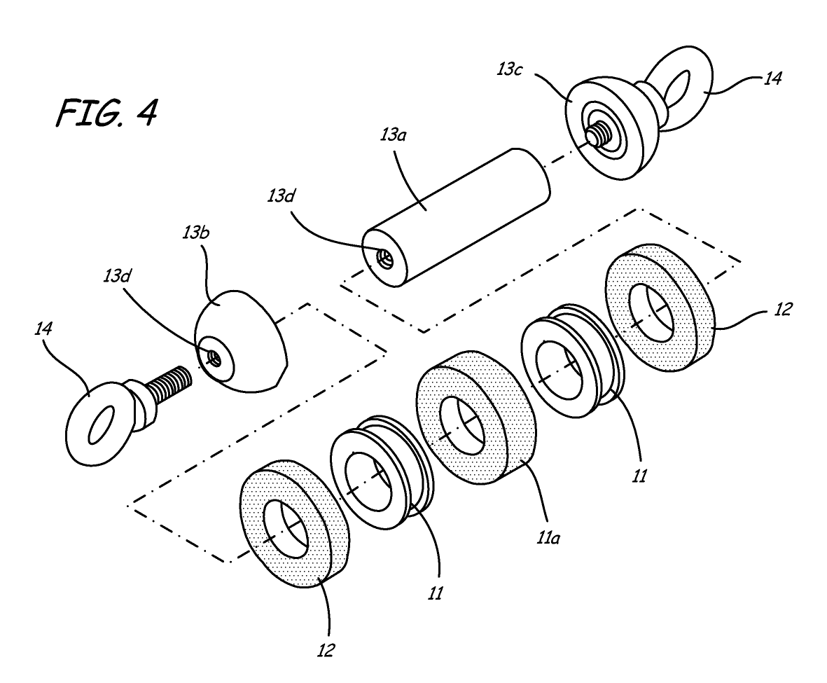

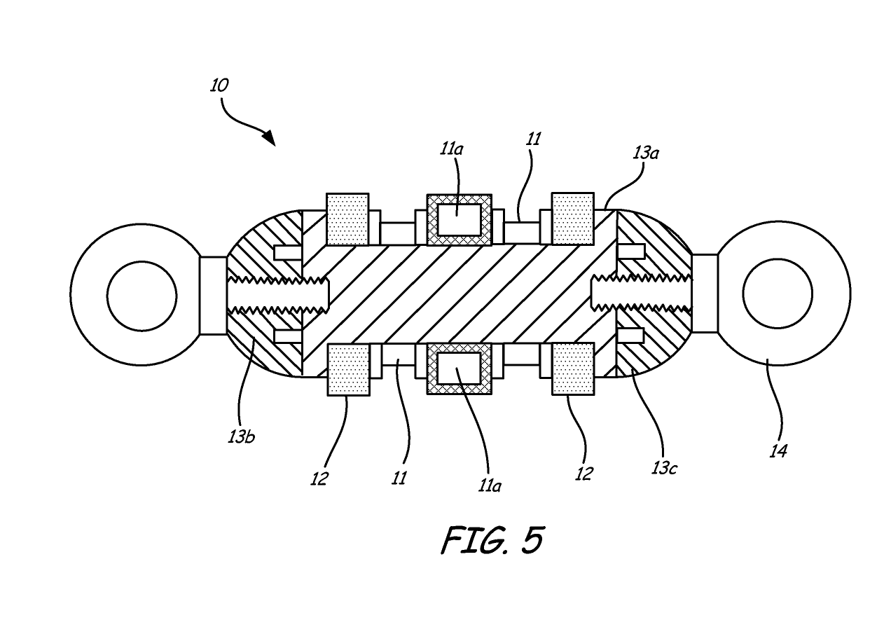

FIGS. 4 and 5 are views of a cleaning member 10 according to other embodiments, showing the different coupled elements being separable in order to make maintenance and repair of the brushes 11, oil applicators/removers 12, fixed body, and ring portions 14 more convenient.

For this end, the fixed body may be divided into a first body 13a to which the brushes 11 and oil applicators/removers 12 are coupled, and first and second body covers 13b and 13c that are coupled at the front and rear ends of the first body 13a by means of the ring portions 14. Screw holes 13d are defined in lengthwise directions in the first body 13a and the first and second body covers 13b and 13c to allow the ring portions 14 to be screw-coupled therein.

In the description below, like reference numerals will be used to denote like elements, and repetitive description thereof will not be given.

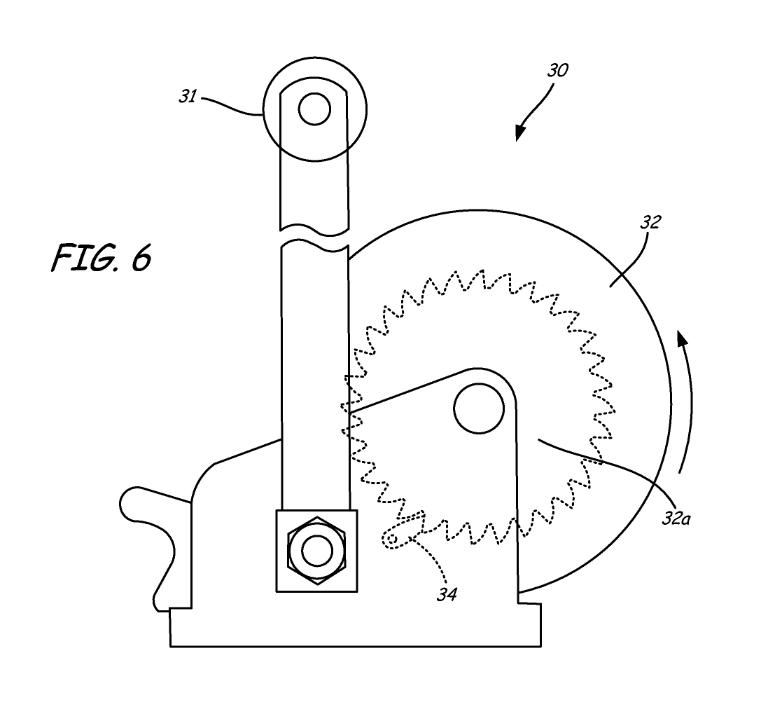

FIG. 6 is a configurative view of a manual moving device according to another embodiment, in which a catch 34 is provided. When the wire 20 or 20′ is pulled, the catch 34 catches on a first gear 32a or 32a′ of the rotating drum 32 or 32′ to prevent unraveling, and when a wire 20 or 20′ is unraveled, the catch 34 is disengaged from the first gear 32a or 32a′ of the rotating drum 32 or 32′ to enable rotation in the unraveling direction.

In the description below, like reference numerals will be used to denote like elements, and repetitive description thereof will not be given.

A gun bore cleaning system according to embodiments can therefore be easily transported by a user, makes operation of equipment convenient, alleviates concerns about equipment malfunctioning, and is accessibly priced. A cleaning member is provided to be inserted into a gun barrel, a wire is connected to either end of the cleaning member, and the free end of either wire is connected to a wire moving device at the shell loading end (breech) and the shell firing end (muzzle), respectively, of the gun barrel. Thus, when a wire is selectively wound at one of either end outside the barrel, the cleaning member is moved to remove soots and other deposits from inside the gun barrel to conveniently clean the barrel. Thus, fast and accurate gun bore cleaning can be achieved for the sake of combat readiness, by reducing personnel requirements and the time taken for cleaning gun barrels by about 30%.

Although embodiments have been described with reference to a number of illustrative embodiments thereof, it should be understood that numerous other modifications and embodiments that will fall within the spirit and scope of the principles of this disclosure as defined in the appended claims can be devised by those having ordinary skill in the art.

What is claimed is:

1. A gun bore cleaning system comprising:
a cleaning member inserted into a gun barrel of a predetermined length, and moved forward and rearward between a shell loading end and a shell firing end of the barrel to remove soots and other deposits from inside the barrel;
a plurality of wires connected to either end of the cleaning member, respectively, to move the cleaning member forward and rearward between the shell loading end and the shell firing end within the barrel; and
a plurality of moving devices for winding and unraveling and moving the wires forward and rearward.

2. The gun bore cleaning system according to claim 1, wherein the cleaning member comprises:
a brush for moving forward and rearward within the barrel while supplying oil to clean the inside of the barrel;
an oil applicator/remover formed at either side of the brush, for absorbing and removing the oil from an inner surface of the barrel cleaned by the brush;
a fixed body coupled to the oil applicator/remover, respectively; and
a ring portion connected and fixed to the fixed body, for the wire to be latched to.

3. The gun bore cleaning system according to claim 2, wherein the fixed body comprises:
a first body to which the brush and the oil applicator/remover are coupled; and
a first and a second body cover coupled by the ring portions to a front and rear end of the first body, respectively,
wherein the first body, the first body cover, and the second body cover define screw holes in a lengthwise direction, for the ring portions to be screw-coupled therein.

4. The gun bore cleaning system according to claim 3, wherein the ring portion is an eye bolt.

5. The gun bore cleaning system according to claim 1, wherein the moving device is for unraveling and pulling the wire or a rope.

6. The gun bore cleaning system according to claim 5, wherein the moving device is a powered moving device, or a manual moving device for unidirectional rotation by means of a rotation lever.

7. The gun bore cleaning system according to claim 6, wherein the manual moving device comprises:
a wire roller guide;
a rotating drum having a unidirectional first gear, for unraveling and pulling wire guided by the wire roller guide; and
a second gear and pulley, configured with a plurality of teeth, for engaging with teeth of the first gear of the rotating drum to prevent rotation in an unraveling direction when the wire is pulled, and for disengaging from the teeth of the first gear of the rotating drum and allowing rotation in the unraveling direction when the wire is unraveled.

8. The gun bore cleaning system according to claim 7, wherein the first and second gears are engaged or disengaged through a connecting gear.

9. The gun bore cleaning system according to claim 6, wherein the manual moving device comprises:
a wire roller guide;
a rotating drum having a unidirectional first gear, for unraveling and pulling wire guided by the wire roller guide; and
a catch for catching on the first gear of the rotating drum and preventing rotation in an unraveling direction when the wire is pulled, and for disengaging from the first gear of the rotating drum to allow rotation in the unraveling direction when the wire is unraveled.
